(19) United States
(12) Patent Application Publication
(10) Pub. No.: US 2012/0185911 A1
(43) Pub. Date: Jul. 19, 2012

(54) MLWEB: A MULTILEVEL WEB APPLICATION FRAMEWORK

(76) Inventors: Khandys Polite, Summerville, SC (US); Thomas Macklin, Charleston, SC (US); John Ashmore, Oakland, CA (US)

(21) Appl. No.: 13/251,158

(22) Filed: Sep. 30, 2011

Related U.S. Application Data
(60) Provisional application No. 61/388,458, filed on Sep. 30, 2010.

(51) Int. Cl. H04L 9/00

(52) U.S. Cl. 726/1

(57) ABSTRACT

A method of transferring data from a server via a web application by receiving a request from a user operating in a disparate security domain for data on a data store. Generating a labeled view of the data requested from the data store, wherein the label-data relationship can be trusted at a level commensurate to the trust level of the operating system. Next, determining if the data is authorized by a security policy with a policy design engine; and then transmitting the data to the user if the data is authorized. Data can also be transferred by receiving a data flow from the user for writing to the data store. Next, the data flow can be inspected for disallowed content, and a determination is made if the data flow is authorized. If the data flow is authorized, mediating the data flow between the user and the data store with a trusted monitor.

### CROSS-REFERENCE TO RELATED APPLICATIONS

This application claims priority to U.S. Provisional Patent Application entitled, “MLWeb: A Multilevel Web Application Framework,” filed on Sep. 30, 2010, and assigned U.S. Application No. 61/388,458; the entire contents of which are hereby incorporated by reference.

### FIELD OF THE INVENTION

The invention relates to communication in a multi-network environment. More specifically, the invention relates to providing a framework for building and deploying medium assurance, web-based applications in a multi-network environment.

### BACKGROUND

Modern military operations are ever-increasingly network centric. In order to facilitate fully functional, network centric operations in the coalition context, military acquisition programs and combatant commanders have implemented entire coalition command, control, communications, computers, intelligence, surveillance, and reconnaissance (C4ISR) network enclaves dedicated to specific missions and/or specific multinational agreements. As these coalitions grow in scope, size, and complexity, the time and money costs of designing, deploying, managing, and using these networks are becoming increasingly obvious. As such, there is an increased interest in moving away from dedicated coalition networks and towards interconnecting existing enclaves using medium and high assurance security systems. Such a network architecture would allow users to participate in coalition C4ISR operations from their primary security enclave, while collaborating with coalition partners residing in different enclaves.

While current Cross Domain Solution (CDS) technologies can offer adequate assurance for network isolation and content transfer policy enforcement services, these systems have difficulty securing many-to-many communications that involve applying granular security policies to complex data types such as office automation files. Also, CDS systems have traditionally been implemented in a manner that supports a single policy that must be accredited by a single approving authority. In order for such traditional CDS systems to be used for interconnecting C4ISR networks in the context of a multinational coalition, they must not only be extended to better support more complex data types, but they must also be extended to support the differences in how coalitions implement, change, and approve cross domain information sharing policies.

More specifically, in the prior art, three types of solutions have traditionally be utilized to handle the ‘multiple networks’ problem: system high solutions, trusted access solutions, and trusted transfer solutions. A system high solution represents the basic solution, which is to maintain completely separate workstations, with each workstation connected to networks with no interconnections with each other. A system high solution set can keep the networks secure from data bleed over or network-based attacks, but is expensive and cumbersome, and also has security problems that stem from users using removable media to transfer data between enclaves.

Trusted access solutions can enable users to maintain one physical workstation that extends a virtualized presence into each separate domain. Trusted access solutions tend to be more elegant and cheaper than a pure system-high solution, but can prevent the user from moving data objects between domains and often require substantial server infrastructure to support.

Finally, trusted transfer solutions, such as guards, can address problems with both system high solutions and trusted access solutions. Guards can enforce nondiscretionary data transfer security policies and move data in between multiple security domains, which can allow a user to interact with users on separate networks from a single workstation and with reasonable security. However, most guards only support a specific data type, and typically do not scale well past two or three separate networks. Furthermore, as applications become increasingly complex and or time-sensitive (i.e., chat related applications), guards tend to either cause unacceptable performance penalties or suffer from a diminished ability to detect and react to security threats.

Accordingly, there remains a need for a system that provides a framework for building and deploying medium assurance, web-based applications in a multi-network environment. The system should enable enterprises to avoid standing up multiple separate network infrastructures for communities of interest that have different but compatible security policies.

### SUMMARY OF THE INVENTION

The invention satisfies the above-described and other needs by providing a method of transferring data from a server via a web application by receiving a request from a user operating on a network in a disparate security domain for data on a multilevel data store. Generating a labeled view of the data requested from the multilevel data store, wherein the label-data relationship can be trusted at a level commensurate to the trust level of the operating system. Next, determining if the data is authorized by a security policy with a policy design engine; and then transmitting the data to the user if the data is authorized. Data can also be transferred by receiving a data flow from the user operating on a network in a disparate security domain for writing to the multilevel data store. Next, the data flow can be inspected for disallowed and mislabeled content, and a determination is made if the data flow is authorized by the security policy. If the data flow is authorized, authorizing the data flow and mediating the data flow between the user and the multilevel data store with a trusted monitor component.

In another embodiment of the invention, a cross domain system can include a plurality of connections to users on networks in disparate security domains. A content server can be configured to extend multilevel web services to the users. A trusted monitor component can be configured to mediate all information flows that occur between the users and the cross domain solutions. A multilevel data store can be configured to read and write data from the users depending on a determination by a policy decision engine on whether the given data is authorized by a security policy.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 is a diagram of a multilevel Hybrid Security Architecture (HSA), in accordance with an exemplary embodiment of the invention.

FIG. 2 depicts the relationship between system subjects and data storage objects in this multilevel HSA database system, in accordance with an exemplary embodiment of the invention.

FIG. 3 depicts a notional view of how read operations would work, in accordance with an exemplary embodiment of the invention.

FIG. 4 depicts a notional information flow from an application requesting a SQL insert via MLSqlite, in accordance with an exemplary embodiment of the invention.

FIG. 5 is a flow chart of the content checker system, in accordance with an exemplary embodiment of the invention.

### DETAILED DESCRIPTION OF EXEMPLARY EMBODIMENTS

Referring now to the drawings, in which like numerals represent like elements, aspects of the exemplary embodiments will be described in connection with the drawing set.

In an exemplary embodiment of the invention, the system described herein, called the MLWeb system, MLWeb Cross-Domain Solution (CDS) or MLWeb framework, addresses many current coalition cross-domain solution capability gaps. In general, the system can allow coalition members to participate in multi-domain, web-based information sharing while enforcing several dynamic, heterogeneous mandatory access control (MAC) and discretionary access control (DAC) security policies. Additionally, because the MLWeb CMS can be built in a modular fashion, the MLWeb framework can be reused as a platform on which developers may build custom CDS applications that are interoperable with existing enterprise services.

More specifically, the MLWeb system can be designed to host web applications with well-defined data schemas that will be served to multiple disparate networks with well-defined security requirements for interconnecting to each other. If data formats and schemas cannot be defined and/or the networks cannot define what they are and are not willing to share with each other, than an MLWeb application will not have a defined policy to enforce. In other words, if an organization wants to integrate a device into their network so that they can apply a “secured” label to their environment, MLWeb would be of nominal use. On the other hand, if an organization has an inter-network security policy that they want to NEATly enforce, then MLWeb would be a possible candidate (NEAT—Nonbypassable, Evaluatable, Always-invoked, and Tamperproof).

Fundamentally, the MLWeb system is a system that is meant to securely extend an integrated set of web content and web applications to users that operate on networks in disparate security domains, or enclaves. Normally, such services would be provided separately from within each network enclave, or a set of information systems that reside in a single security domain, and any information to be shared among the enclaves would have to be moved by external means. However, MLWeb can have a separate instance of a web server for extending web content and web-based services into each security enclave. Each of these MLWeb enclave's web interfaces can subscribe to a set of trusted system services that can mediate all cross-domain information flows. These subsystems can perform an aspect of enforcing all mandatory and some discretionary security policies that govern the flow of information between the connected enclaves.

In general, the system security aspects of the subsystems can include the following: (1) Ensure that all data introduced into the system can be processed in a manner that complies with the system's security policy; (2) Ensure that no subject in an enclave can access system data that has been posted to a web space to which the subject's enclave has not been granted access; (3) Ensure that the policy enforced by the system is in compliance with the accredited policy for that system; (4) Extend administrative services to trusted system subjects via a secure, high-trust communications path (i.e., as trusted path, physical connection to server, etc.); and (5) Ensure that Discretionary Access Control (DAC) mechanisms are protected by mandatory access controls from modification by their subscribers. For example, an Access Control List (ACL) for a web space accessed by domain “A” can be stored in a manner that domain “A” does not have MAC access to modify the ACL.

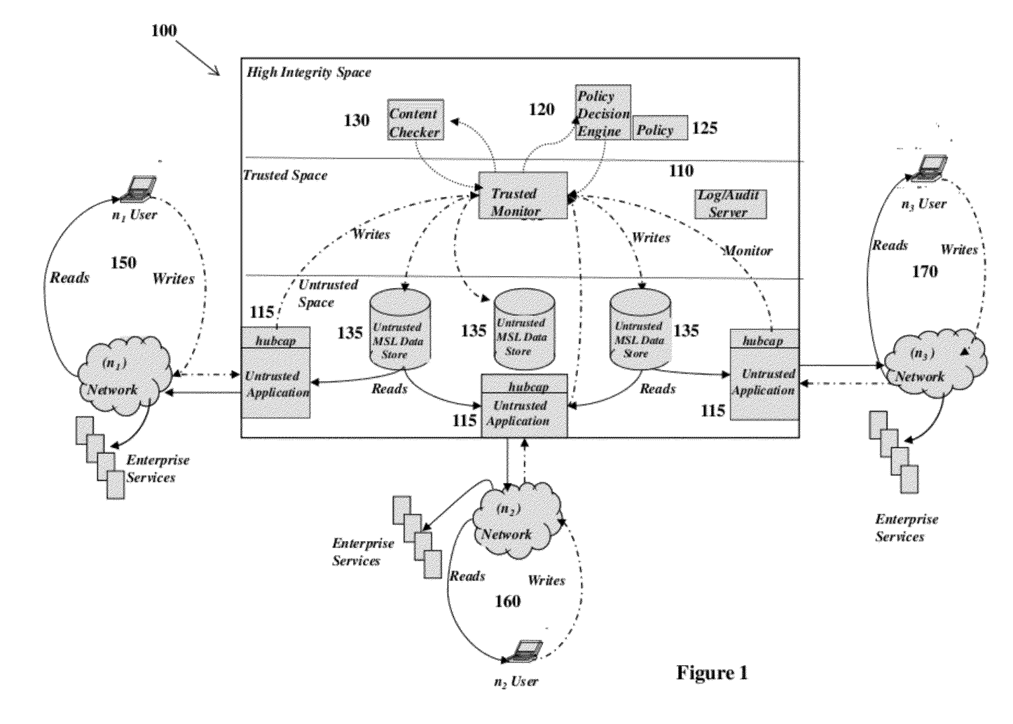

FIG. 1 depicts a multilevel Hybrid Security Architecture (HSA) in accordance with an exemplary embodiment of the invention. The MLWeb system 100 is built around the HSA so any web application built on the MLWeb framework can operate as a multilevel system, rather than a multi-domain access solution or a traditional guarding solution. In this architecture, all data read operations can be mediated by the system's operating system, while all write requests can be mediated by the system's trusted monitor. As such, Mandatory Access Control (MAC) policy enforcement assurance can be inherited from the operating system for read operations, while MAC policy enforcement can be inherited from the system's trusted monitor for write operations.

More specifically, the hybrid architecture introduces Multi-Level Secure (MLS) technology into environments consisting of Multiple Security Levels (MSL), and can apply this schema as the basis for a Multi-Level Web (MLWeb) server. This MLWeb server can eliminate cross-domain content synchronization problems, reduce administrative burdens, and almost certainly reduce the cost of sharing information. This unique hybrid architecture can consist of at least three functions: (1) web services hosted on a Multi-Level Secure (MLS) server; (2) individual web servers at each network level (MSL); and (3) a guard function that mediates data writes between network levels via a trusted process. In an exemplary embodiment of the invention, these three functions can be integrated on a single trusted server. The underlying Operating System (OS) of the ML Web Server can be STOP 6.x, developed by BAE Systems. The hardware platform can be the XTS-400/410. STOP has been evaluated at the EAL 5 (Augmented) level.

In an exemplary embodiment of the invention, and associated with FIG. 1, MLWeb can include the following subsystems that perform the system security aspects discussed above. A brief description of each subsystem will be discussed here; however, more detailed explanations may be provided later. A single level, untrusted application server 115, such as a content management server (CMS) can be configured to provide a secure, multilevel portal experience to users in connected single level enclaves. A trusted monitor component 105 can mediate all information flows that occur between connected enclaves. A multilevel relational database management system (RDBMS) is realized by distributing database functionality in different components that are protected by the mandatory access control mechanisms provided by the host operation system. This multilevel RDBMS generates a labeled view of data pulled from the multiple, single level data stores 135. The label-data relationship can be trusted at a level commensurate to the trust level of the OS, as the label is derived from the mandatory access control attributes associated with the data's single level data store 135.

A policy decision engine 120 can determine if a given data flow is authorized by the system's security policy. A policy analysis engine 125 can validate that every flow granted by an accredited, high level policy can be granted by an implementation of that policy, and that every flow disallowed by an accredited high level policy can disallowed by an implementation of that policy. A log server 110 can be provided that is a centralized server daemon that collects, organizes and logs data according to a centralized logging policy. Additionally, this process can commit various log events to the audit log based on the system's audit policy.

A content checker 130 can inspect all content for disallowed, malformed, or mislabeled content on behalf of the trusted monitor component 105 prior to a data flow being authorized by the trusted monitor component 105. These inspections can include security label analysis, file type checking, file content inspection, watermark verification, or stenography inspections. Because certain file inspection tools, including sub-file extraction tools, are preferred by different organizations, the content checker is implemented as an open content checking framework. An integrator can ‘mix and match’ different content checking and/or extraction modules within the MLWeb content checking framework in a manner that suites their organizational policies, objectives, and budget.

Each of the above subsystems is designed in a service-oriented manner, such that every MLWeb subsystem can integrate with a corresponding service-oriented architecture. For example, the content checker 130 could subscribe to external content checking services, or an untrusted application server 115 could subscribe to enterprise content search services, authentication services, etc.

In addition to the above subsystems, the MLWeb system 100 can also have a daemonator, not represented in FIG. 1, which is a lightweight process executive similar to “init” in most UNIX systems. This process can start and stop untrusted application processes according to a configuration file. This process can be configured so that it does not communicate with any other system processes after it completes its startup routine. Furthermore, an authentication server can provide cross-domain identity management services. A content search engine can allow users to search the multiple, single level data stores 135. Finally, an MLWeb management system, or user management system (UMS), can provide a user interface to trusted system subjects for managing the MLWeb system

The multilevel HSA architecture of FIG. 1 addresses several limitations of prior art systems to support additional capabilities. One example of a component with expanded capabilities is the trusted monitor decision support component 105, or trusted monitor 105. The trusted monitor 105 is the system's only interface that can have sufficient privilege for executing cross-domain data transfers (i.e., violate the trusted operating systems' native MAC policy.) As such, the trusted monitor 105 can be thought of as the MLWeb system's “guarding function.” The trusted monitor 105 can communicate with other MLWeb processes via an MLWebMessage messaging function. The trusted monitor 105 can process the following different types of messages: (1) Administrative messages, such as telling the system to shut down; (2) Data flow messages, such as uploading full or partial files, or requests to obtain or release advisory file locks; (3) Content checker messages, such as asking the content checker to analyze content; and (4) Policy query messages, which can be used to “ask” the policy decision engine 120 to approve or disapprove file transfer requests.

Administrative messages can only be accepted from the administrative subsystem, but can be forwarded to instances of the appropriate server subsystem(s) according to the MAC policy. Policy query messages can only be passed between the trusted monitor 105 and the policy decision engine 120 subsystems. Content checker messages can only be passed between the content checker system 130 and trusted monitor 105 subsystems. Data flow messages can be accepted from instances of the content management server 115 subsystems and logic server subsystems, but can be forwarded to other content management server instances according to the mandatory access control policy. Data flow messages can relate to content posting events or file locking events.

In addition to processing messages, the trusted monitor 105 can provide multiple security services: For example, the trusted monitor 105 can act as a controlled interface between all unprivileged processes within the MLWeb System 100. While the trusted monitor 105 can be capable of passing any data it receives from one domain to another, it must ensure that data is transferred between subsystems only in accordance with the system's mandatory access control policy. The trusted monitor 105 can properly act on each message according to the message type, contents, source, and other properties. Additionally, it can be responsible for the proper initialization and shutdown of each subsystem. Finally, the trusted monitor 105 can audit events according to the system's selective auditing configuration.

The trusted monitor 105 can also have multiple security dependencies. For example, the trusted monitor 105 can make use of privilege extension mechanisms of its host-trusted operating system, as such; the subsystem can rely on the trusted operating system to correctly bracket its privilege augmentations. The trusted monitor 105 can make message routing and processing decisions based on its configuration settings. Furthermore, the trusted monitor 105 can ensure the messages it receives are of a fixed size, with the size based on the message type. The system can be configured that while the trusted monitor 105 is running, no other process on the system can modify any of the multilevel data. Finally, as messages and files flow through the system the trusted monitor 105 can ensure isolation of the data as it is handed off to each subsystem via MAC and DAC.

For communications, the trusted monitor 105 can have a unique communications channel for communicating with each instantiation of each of the applicable subsystems (e.g., logic server, content management server). Each channel can be isolated from other channels via mandatory access controls. However, there may be intermediate processes to multiplex multiple connections from such processes, onto one connection with the trusted monitor 105. The trusted monitor 105 can only be started and stopped by way of a trusted path at the local system console.

The trusted monitor 105 can use a configuration file for defining which enclaves are enabled, and which are disabled. All configurable parameters, including audit parameters can be documented to describe the allowed values, the purpose of the setting, and any significant consequences of modifying the setting.

The multilevel data store 135 is a collection of distributed software modules meant to interoperate in such a manner as to emulate a “COTS”-style SQL database. The multilevel data store 135 subsystem can provide a single, abstract, labeled interface into the multiple single-level database files maintained at different MAC levels throughout the system. The subsystem can also emulate POSIX file advisory locking (i.e., ‘fnctl’) across the multiple security levels. Finally, the subsystem can be responsible for ensuring that untrusted processes (i.e., the content management server 115 subsystem) cannot modify the data scheme/data model for the system in a manner that violates the scheme defined by the system administrator.

The multilevel data store 135 has at least three main responsibilities and related components: (1) reading from the data store, which can be handled by Mlsqlite; (2) writing to the data store, which can be handled by the logic server; and (3) advisory locking of files within the data store to avoid data corruption, which can be handled by the lock engine within the trusted monitor 105.

Mlsqlite is a multi-level, SQL-compliant, database management system which can be built on a sqlite base, known to one of ordinary skill in the art. Mlsqlite can be used by various untrusted processes to execute database reads locally, but can route database write requests to the logic server for execution. Mlsqlite and the logic server can be separated by the trusted monitor 105 and by the “Hubcap” server, which can act as a communications layer or gateway between Mlsqlite and the trusted monitor 105.

The logic server can be an untrusted process that separates the trusted monitor 105 from the functionality of the logical placement of data into a data store content management server 115. Separating this function from the entity that provides it can yield a more decoupled, modular design and better privilege bracketing. Each instance of the logic server can receive and process messages from the trusted monitor 105 and insert the relevant information into the instance of the server's corresponding, single-level data store. There can be at least one logic server per valid security data label supported by the MLWeb application's security policy. The logic server and the hubcap server can each use the Reactor Framework² (known to one of ordinary skill in the art) for event-driven demultiplexing of various communications, timing, and signal events.

The advisory file locking mechanism managed by the trusted monitor 105 can be consulted by the logic server prior to invoking write accesses within the data store. The advisory file locking mechanism can allow any number of processes to read a file or file portion at the same time but can (logically, not actually) forbid access by any other process when a file is locked for write access and can (logically, not actually) deny write lock requests for any portion of a file upon which an active read lock exists. The advisory file locking mechanism can be based on the interface, command set, and specification of Linux fcntl, known to one of ordinary skill in the art.

The multilevel data store 135 can be responsible for transforming SQL requests generated by various untrusted processes into MLWebMessage messages to be forwarded to the trusted monitor 105. It can also be responsible for inferring the data labels of disparate database files maintained at multiple security levels, and translating these labels into the application and/or human-readable labels used by the content management server 115 subsystem. The multilevel data store 135 subsystem can also be responsible for minimizing the bandwidth of any potential covert channels associated with the file advisory locking communications channels.

The logic server can be written to provide at most application layer security, but it does not directly affect the mandatory access control policy of the system. The logic server can provide a mechanism for enforcement of database schema. Requests which are poorly formed or which otherwise violate the schema of the supported data store can be rejected by the logic server. The communications gateway between Mlsqlite and the trusted monitor 105 can pass only those messages, which are of a predetermined type.

The multilevel data store 135 can depend on the STOP OS' MAC mechanisms for ensuring that the disparate database files are properly protected. The subsystem can also depend on the trusted monitor 105 and the STOP OS to properly mediate all cross-domain information flows. The multilevel data store 135 can depend on user interface subsystems (i.e., the content management server 115) to properly associate the MAC labels of data with human-readable labels when presenting the data. Finally, the multilevel data store 135 subsystem can depend on the logic server subsystem to securely mediate operations that insert information into the data store, according to the system's data scheme/data model. The logic server is dependent upon the security of the operating system, the data store, and the other components of MLWeb.

The multilevel data store 135 can have a provision for mediating communications between the content management server 115 subsystem and the trusted monitor 105. It can also have a mechanism for communications with the logic server subsystem. Mlsqlite can interface with the trusted monitor 105 via a configurable communications gateway; i.e., the hubcap server. The interface between the logic server and the trusted monitor 105 can use a set of Unix named pipes. Messages can be passed from the trusted monitor 105 to the appropriate instance of the logic server. Once a message is received, the logic server can then manipulate the data and interface with the data store to provide persistent data storage services within the system.

System administrators can define a data scheme/data model that defines the information that may and/or may not be posted to different portions of the multilevel data store and by whom. The logic server can provide an interface, which is configurable to accommodate various types of data stores including XML databases, flat file databases, and SQL-compliant databases. The logic server can employ the Adapter Design Pattern, known to one of ordinary skill in the art, to permit access to different types of data stores via a common interface. The type, name, and location of data stores can all be configurable parameters of the logic server as is the underlying mechanism for interprocess communications used by the logic server. Both ends of the communications gateway between Mlsqlite and the trusted monitor 105 can be configurable as to the other connection type specific parameters. For example, if Mlsqlite can use a specific pair of named pipes, then the names of these pipes can be a configurable parameter. Finally, the various components for the multilevel data store can have a provision for configuring auditing and logging parameters.

The Policy Decision Engine 120 (PDE) can be responsible for providing policy permission checking services for the trusted monitor 105. Upon initialization, the policy decision engine 120 can parse the system policy object, and initiate communications with the trusted monitor 105. Subsequently, when the trusted monitor 105 receives a service request from a content management server 115 or from the MLWeb Management System, the trusted monitor 105 can query the policy decision engine 120 to determine if the data processing service request is permitted by the system's policy object. The policy decision engine 120 can then analyze the elements of the policy query, and return a “Boolean” response to the trusted monitor 105.

For any given data service request received by the trusted monitor 105, the policy decision engine 120 can be responsible for determining whether or not the system's policy object “opinion” about the request, based on the facts presented to it by the trusted monitor 105 in the monitor's policy query. For example, if a request states that network A wishes to release a jpeg file to networks A and B, then the policy decision engine 120 will make a determination as to whether this operation is allowed, disallowed, or ungoverned by the system's policy object. The policy decision engine 120 can respond with one of following decisions: ALLOWED, NOT ALLOWED, DENIED, NOT DENIED, UNDETERMINED, or other decisions contemplated by the system administrators. The policy decision engine 120 can support any of these responses.

The policy decision engine 120 can respond to the policy queries from the trusted monitor 105 strictly according to the system's policy object. As such, if the system policy object has contradictions, circular logic, an incorrect policy, etc., then it may not necessarily provide the expected response. Finally, the policy decision engine 120 can be implemented to parse system policy objects in a manner that maps directly to a mathematical algorithm for MLWeb parsing policy objects. For these reasons, the policy language and policy processing algorithms must be properly analyzed for correctness (i.e., rigorously certified.)

The only communications path to or from the policy decision engine 120 can be via the trusted monitor 105. Furthermore, the trusted monitor 105 can only send messages to the policy decision engine 120 that have been formatted according to one of the explicitly defined types of policy query MLWebMessage messages.

The policy decision engine 120 can have configurable parameters for logging and auditing and for the policy object itself. The policy object can be loaded at initialization, and cannot be modified during runtime.

The policy analysis engine 125 can be part of the MLWeb system, but it is typically not a part of MLWeb's runtime environment. The purpose of the policy analysis engine 125 is to establish the relationship between an accredited high-level policy and an implementation of that policy. For example, suppose four divisions within an enterprise were implementing MLWeb systems. The enterprise may then accredit one high level policy for the enterprise, and allow the four divisions to implement their own implementation policies, so long as the policy analysis engine 125 can determine that they each have policy compliance with the enterprise's high level policy.

The policy analysis engine 125 does not directly provide any system security functionality. Rather, it can be used as a tool to aid in providing evidence to accreditors that an implementation of a MLWeb system policy is compliant with an accredited high level policy. However, if the policy analysis engine 125 detects that an implementation of a system policy permits an action that is unregulated by the high level policy, it can warn the user. Similarly, the policy analysis user interface can warn the user if any rules within a policy will seriously degrade system performance (i.e., they will result in a runtime complexity worst-case policy search almost every time, etc.).

The policy analysis engine 125 can be implemented to parse system policy objects in a manner that maps directly to a mathematical algorithm for MLWeb parsing policy objects. For these reasons, the policy language and policy processing algorithms must be properly analyzed for correctness (i.e., rigorously certified). The Policy Analysis Engine can interface with the user via a graphical user interface and/or a command line interface. The policy analysis engine 125 can allow a user to specify a high level policy object and an implementation policy to be analyzed.

The content checker subsystem 130 can be responsible for providing content validation and analysis services to the trusted monitor 105. Prior to moving a data object between security domains, the trusted monitor 105 can first submit the content to the content checker subsystem 130. The content checker subsystem 130 can then analyze the object in order to determine as precisely as possible the actual type of the object, along with all of the object subtypes that may be embedded in the object. This information can be provided to the trusted monitor 105, which can then use the information when making the final determination as to whether or not the information will be transferred between security domains. For example, if domain A wishes to release a spreadsheet to domains B and C, the monitor can first submit the spreadsheet to the content checker subsystem 130. The content checker subsystem 130 can then perform the necessary analysis to ensure that the object is in fact a spreadsheet, and may perhaps scan to see if the spreadsheet has any embedded objects (e.g., a bitmap). The results of the analysis can then be returned to the trusted monitor 105, which can make a determination as to whether to release the object to B and C.

The content checker subsystem 130 can be as modular as possible in order to accommodate changes in the format of a given object type. For example, if a new format for zip archive files is released, then the content checker subsystem 130 can be able to incorporate a new filter for this new data type without recompiling the source code (re-linking is not desirable, but may be acceptable).

The content checker subsystem 130 can consist of at least four processes and some number of validators that vary based on the requirements of the system implementation. The four processes can be: 1) user interface, 2) message router, 3) quarantine manager, and 4) file processor. Some examples of validators can include bmp, gif, jpeg, html, MSoffice, pdf, rtf, xml, and zip. The individual validators can be responsible for validating the file format of the data object. Of particular interest is the validator for Microsoft Office files (i.e., the MSoffice validator). The system can use a commercial content validating sidecar, which can reside on a machine separate from the machine on which the content checker subsystem 130 resides. The content checker subsystem 130 (or, more specifically, the file processor) can communicate with the sidecar via a network protocol.

The primary purpose of the content checker subsystem 130 is to reduce the possibility that a user may be able to transfer data object types through the system in a manner that is inconsistent with the cross-domain data transfer policy. For example, the content checker subsystem 130 can ensure that a spreadsheet object submitted for transfer from domain A to domain B is in fact a spreadsheet, and not, say, a zip archive. Furthermore, the content checker subsystem 130 can analyze the spreadsheet to determine the types of any embedded objects. This information can be submitted back to the trusted monitor 105, which can make the final determination as to whether the content may be transferred. If an object is complex beyond some pre-defined threshold, then the content filter can determine that the type of the object is not discernible.

The security of the content checker subsystem 130 depends on the security of the operating system and the trusted monitor 105. The content checker subsystem 130 can only interface with the trusted monitor 105 via MLCP. The content checker subsystem 130 can return the results of the analysis of the data object, which can include information about the object type and possibly the types of any embedded objects. Internally, the content checker subsystem 130 processes will communicate via named and unnamed pipes.

The content checker subsystem 130 can be configurable to operate in one of three execution modes: 1) standalone with MLCP enabled, 2) standalone with MLCP disabled, and 3) MLWeb with MLCP enabled. Further, it can be configurable to interface with different content checking modules. Finally, it can have configurable logging and auditing settings, and have a configurable complexity threshold property.

The content management server (CMS) 115, which can be a single level, untrusted application server, is the system's external interface. It can provide a user interface viewable through a browser, and may provide a web services interface as well. The content management server 115 subsystem can be made up of two main components: (1) the web server and (2) the content management system. The web server can be a modified version of an open source software package. This software can be non-threaded and can have a minimal code base. The web server typically already contains the functionality to support Secure Socket Layer (SSL) and FastCGI. All incoming requests can be made through the web server. If a request is for a Common Gateway Interface (CGI), the web server can spawn a new process, which can handle the logic of the request.

The CGI programs can be the content management system. For read oriented operations, they will not interface directly with the trusted monitor 105. Instead, they can process data as if it were residing on an untrusted Operating System (OS). The interface to the multilevel data store 135 can be accomplished via a plug-in created specifically for the MLWeb multilevel data store 135. All write operations can be mediated by a provision within the multilevel data store 135 subsystem that acts as abstraction of the trusted monitor 105 and the logic server.

The content management system/CGI component of the content management server 115 can replicate some of the security checks done by the policy decision engine 120, trusted monitor 105, and the content checker subsystem 130. These checks can be meant to provide a quick response to the user of an estimate for whether or not the content is valid and will not make it through the entire system. While any operation request rejected by the content management server 115 subsystem can be rejected by MLWeb, operations allowed by the content management server 115 subsystem will not necessarily be allowed by MLWeb. The operation request can still be processed through all of the MAC—enforcement mechanisms of the MLWeb system, and thus system MAC enforcement does not rest with the content management server 115. The content management server 115 can implement DAC in the form of restricting the actions of uploading files and changing content. The DAC policy can be enforced via session management and restriction of user navigation to route through the appropriate channels. DAC mechanisms can also be available to restrict reads of content through a configuration setting. The communication mechanism for communication between client and server allows for protected transmission using an implementation of OpenSSL, known to one of ordinary skill in the art. Additionally, all user input can be filtered by the CGI for malicious content.

The security of the content management server 115 can reside with the operating system to keep disparate security domains separate. The implementation of OpenSSL to secure communication between client and server relics on the efficiency and randomness of an entropy daemon. The content management server 115 depends on the multilevel data store 135 subsystem, the trusted monitor 105, and the logic server to properly process any service requests and/or system status inquiries. The content management server 115 can use the DAC policy as defined in the MLWeb Management System. The content management server 115 can rely on the authentication and access control subsystem to properly authenticate and establish the identity of system subjects.

The content management server 115 can interface both with the user, the file system, and with the multilevel data store 135. It can interface with the user by providing a graphical user interface via a browser to display and manipulate content. It can interface with the file system by doing reads to display the appropriate data back to the user and can also write uploaded content (files) for processing by the trusted monitor 105. The interface to the multilevel data store 135 can be accomplished via an embedded multilevel data store 135 accessor component for the MLWeb system. Logically, the interface can be nothing more than standard SQL-compliant queries. However, the content management server 115 can interface with a provision of the multilevel data store 135 subsystem that will abstract various services for the content management server 115, such as database insert requests (which must go through the trusted monitor 105), and file system advisory locks. The communications between this provision of the multilevel data store 135 and the content management server 115 CGI processes can occur via Unix Domain Sockets. The content management server 115 can communicate with the authentication subsystem via web services.

There can be multiple configurable parameters for the content management server 115: SSL certificate specification, SSL on/off toggle, virtual server configuration, and CGI locations are a few examples of content management server 115 configuration settings.

The authentication system can use an access control scheme that is largely decoupled from the authentication mechanism. Ideally, the authentication system can support multiple authentication mechanisms, as authentication mechanism requirements often vary from environment to environment. The access control mechanism can be standards-based, with an emphasis placed on the following, in order of importance: security/assurance, interoperability with other web applications/services, and code reuse.

There can be a subsystem that extends a flexible authentication model from the authentication system to users. This system should accommodate basic and medium strength authentication mechanisms, and may extend strong authentication as well. The system can have a way to use the status of a user's authentication as means for enforcing access control decisions based on the DAC policy as defined by the content management server 115.

Regardless of the strength of the authentication mechanism, the subsystem's composite strength level will be bound in some way by the strength of the security protecting the information communicated between the authentication service and the content management server 115. Similarly, the security posture of the client's host/operating environment can affect the authentication assurance, as it may be possible for an adversary to compromise a valid user's host and thus misuse an active session. Therefore, the site-specific administrator and user OPSEC policies can also affect system assurance (i.e., do user's share credentials'? Do administrators give universal DAC access? etc.).

There can be a provision for the content management server 115 to communicate with the authentication subsystem that may be local to the MLWeb server or connected via the network, based on the specific implementation of a given system. Discretionary access control decisions can be made directly by the content management server 115. Interprocess communications between the content management server 115 subsystem and the trusted monitor 105 can be handled by the Hubcap communications gateway of the multilevel data store 135 Subsystem.

The source and method for authenticating users can be specified in the content management server 115. The DAC policy for posted content can be defined by the MLWeb Management System. The content management server 115 can also have a provision for configuring the logging and auditing parameters.

The MLWeb management system can be a subsystem of MLWeb that can securely extend administrative services to trusted system subjects and objects. The primary use of the system can be to enable the creation, modification, or deletion of MAC-protected resources, such as web spaces (sites), MSL data store levels, or system user Access Control Lists (ACLs). These settings can constitute the majority of the system's DAC policy. The MAC protection mechanisms can be redundant to those built into the underlying MLWeb architecture at the lower tiers. Additionally, there can be a mechanism for managing system logs, the system audit trail, and system backups. Whenever practical, there can be some mechanism for implementing role separation for administrative functions.

The MLWeb Management System can enable administrators to create MAC and DAC-protected resources. The MAC labels that each resource can be assigned can be drawn from a system configuration file that can only be modified outside the domain of the content management server 115 or the MLWeb management system. The MLWeb management system can also have a provision for configuring which administrative actions are maintained in the system's audit trail. Additionally, all networks can have TCP/IP access to a multi-level authentication service to provide strong authentication for users.

As the MLWeb Management subsystem is meant to extend administrative services to trusted system subjects, it is imperative that access to this subsystem be strictly controlled. It can assumed that nontechnical controls will be the primary means for protecting the administrative interface(s).

The administrative interface can only be accessible via the local console. All communications to the multi-level databases can be done by proxy via the multilevel data store adapter module. The MLWeb Management Subsystem can have a single MLWebMessage connection to the trusted monitor 105 for passing file upload and delete messages via a pair of named pipes.

The administrative actions that are to be logged in the audit trail can be a configurable setting. The valid resource attributes (i.e., MAC Labels, etc.) can be based on the configuration of the MLWeb policy object.

The MLWeb log server 110 can establish a one-way connection by which each security domain within the MLWeb system can send log messages to the log server 110. Once these connections are established, the log server 110 can collect messages from each enclave and commit the messages to the system log and audit trails according to the system's central logging and auditing policies. Any log and/or audit events within the log server 110 can be committed to the same logging and audit trails.

The MLWeb log server 110 subsystem can be responsible for maintaining and protecting the system's log and audit files. Because each security domain within MLWeb can be segregated from other subsystems by the operating system's MAC enforcement mechanisms, the log server 110 must augment its privilege set to read data from the various security enclaves.

This log server 110 system can depend on the operating system to properly execute process privilege upgrades and downgrades, along with the MAC and DAC protection of the log and audit files. The log server 110 subsystem can communicate with each security domain within the MLWeb system via a single one-way named pipe. For each domain specified in the trusted monitor's configuration file, there can be a pipe created that all processes within the domain will write to.

The communications interfaces to be created can be defined in the trusted monitors configuration file. Additionally, the log server 110 can have a configuration file that defines the system's logging and audit policies. This configuration file can define any relevant parameters such as which types of events are committed to the log and/or audit trails, how large the log files are allowed to get, the accuracy of the timestamps, etc.

The daemonator subsystem can be a simple server daemon that is meant to start and stop untrusted and unprivileged processes related to the MLWeb system that have no direct relationship to the trusted monitor. By decoupling this function from the trusted monitor can reduce the complexity and increases the assurance of the trusted monitor subsystem. Additionally, the separation of application process management form MLWeb framework process management can decouple the MLWeb application framework architecture from the MLWeb application layer.

The MLWeb daemonator can simply start untrusted processes upon startup and kill them upon shutdown. In order to perform the actual startup and shutdown tasks, the daemonator process can temporarily augment privileges in order to perform the process execution and kill operations. This system depends on the operating system to properly execute process privilege upgrades and downgrades. The daemonator subsystem can have a configuration file that defines which processes should be launched and in which security domain, and may optionally provide a specialized mechanism for stopping that process at shutdown.

In an exemplary embodiment of the invention, the system, as it runs, can be composed of the STOP operating system, running on an XTS-400 computer, at least one trust monitor 105, at least on log server 110, at least one daemonator, at least one content checker subsystem 130 (and, if applicable, one sidecar server for complex file analysis), at least policy decision engine 120, at least one content management server 115 per attached enclave (and, if applicable, one multilevel authentication server) and at up to one logic server per combination of attached enclaves, that includes that of the owning country. For example, a US-owned MLWeb system, with American, British, and Iraqi enclaves attached, could have the following logic servers:

1. US only; Britain and Iraq cannot read or write this information

2. US and Britain only; Iraq cannot read or write this information

3. US and Iraq only; Britain cannot read or write this information

4. US, Britain, and Iraq; all three can read and write this information

If one adds another attached enclave, the number of possible logic servers doubles. The number of logic servers that a system might need, can be calculated as 2ⁿ⁻¹, where n is the number of enclaves attached.

With the above provided general descriptions of the subsystems of the MLWeb system 100, areas of where the architectures overcomes limitations of the prior art will be discussed. Many applications have complex security policies, and as the certification process for privileged/trusted code bases, policy decision support is often too complex to implement directly in the trusted monitor. Therefore, the trusted monitor 105 can be extended to support decision support plug-ins. Plug-ins can be integrated to support many different functions, such as static file analysis, content transfer policy decision support, and file system advisory locking emulation. Plug-ins can also be implemented as separate processes when timeliness of service is not critical (e.g, for file analysis and policy support) or as dynamically linked libraries when operations are time sensitive (e.g., advisory locking).

Another limitation of prior art architecture is that the trusted monitor 105 was responsible for executing all data writes. As such, extensive business logic was implemented in the trusted monitor 105, which limited system assurance and flexibility. In an exemplary embodiment of the invention, the trusted monitor 105 can be extended to forward all appropriate data write requests to flexible and extensible data filtering and marshalling processes called logic servers.

Additionally, the prior art architecture had a very ad-hoc nature of system logging, where each process maintained its own log, while the operating system maintained its own audit trail. This architecture configuration made log management and analysis practically impossible. In an exemplary embodiment of the invention, a central logging and auditing server 115 can be implemented in the framework so that all logging and auditing can be performed by a single facility.

Finally, in the prior art architecture, the trusted monitor decision support component 105 at the core of the multilevel HSA could maintain only one communication channel into each network enclave. As such, concurrent applications, such as most web applications, would not be able to receive responses in a reliable manner. Therefore, in an exemplary embodiment of the invention, a communications multiplexer 115, also called the “hubcap,” was implemented to facilitate concurrent, reliable, bi-directional communications between networked application instances and the system's trusted monitor decision support component 105.

In addition to the added capabilities of the multilevel HSA architecture, there were unique subsystems to the framework. For example, while there are prior art multilevel database models, they could not function in the multilevel HSA environment in accordance with an exemplary embodiment of the invention. In order for a database subsystem to work with the multilevel HSA framework, the multilevel data store must be composed of multiple single level (MSL) data stores that are protected by the Operating System's (OS) security policy enforcement mechanisms. More specifically, the database subsystem must leverage the assurance inherent in the OS's MAC labeling system rather than implement its own.

In order to satisfy the above requirements, the database storage can be distributed across multiple files. Each database file has an OS MAC label commensurate to the security label of the data which it will store. In such an arrangement, the multilevel data store 135 is an aggregate of multiple single-level data stores. In this architecture, given user u₁ on network n₁, u₁ would only be able to access data located in data store dₓε{d₁, d₂, . . . , dₙ} and if n₁ had MAC access to dₓ. Simply put, users in a given network security enclave are only able to access data stored in a single level data store to which their network has access, regardless of the actual clearance of the user.

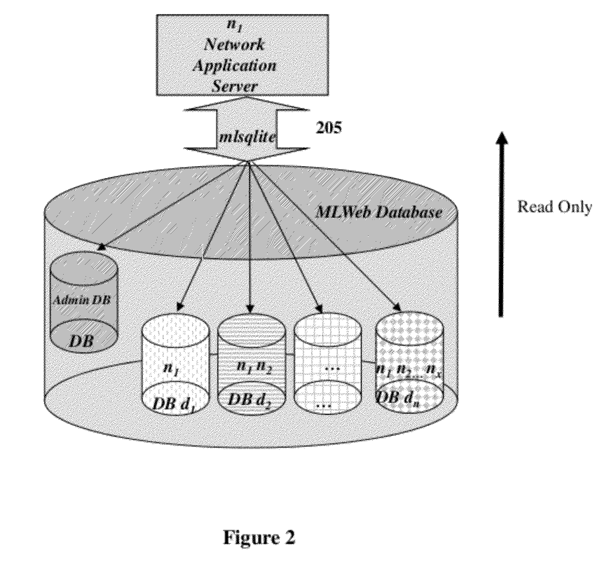

FIG. 2 depicts the relationship between system subjects and data storage objects in this multilevel HSA database system, in accordance with an exemplary embodiment of the invention. In an exemplary embodiment of the invention, the multilevel HSA database system can be implemented using the Sqlite3 open source dataset system, as represented in FIG. 2 as MLSqlite 205. At a high level, MLSqlite is simply a view of multiple aggregated databases that are differentiated by tagging the data source with a security label. However, as views only support read operations, MLSqlite would not be very useful without modifications to enable network subjects to update the various single level database objects from which their database view is composed. Therefore, in an exemplary embodiment of the invention, the following extensions were included to make MLSqlite multilevel: facilitating advisory locking services via inter process communications (IPC), primary key security policy enforcement, the prohibition of a ‘label’ row, and execution of database modification transactions via IPC.

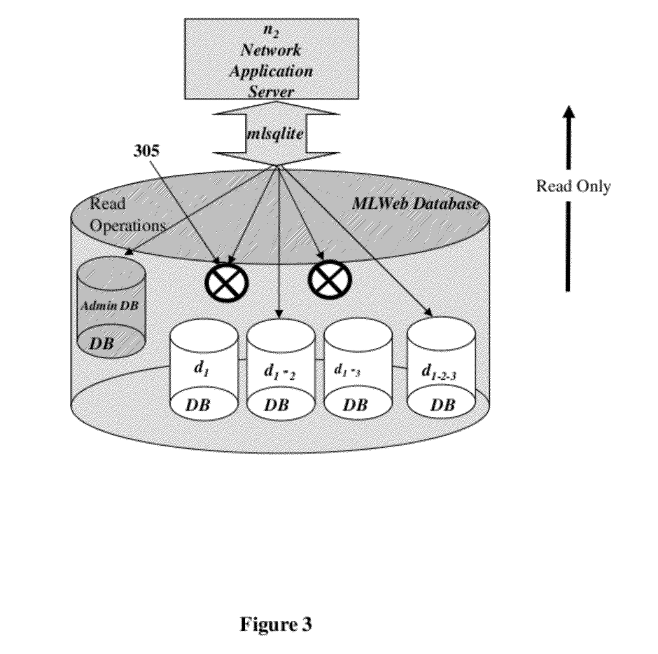

FIG. 3 depicts a notional view of how read operations would work, in an exemplary embodiment of the invention. One important aspect of this arrangement is its support for dynamic MAC policies. In FIG. 3, if partner n₂ were to leave the coalition, n₂ could simply be removed from the system, the d₁₋₂ data store could be removed, and data from the d₁₋₂₋₃ data store could either be deleted outright, migrated into the d₁₋₂ data store, or left in the d₁₋₂₋₃ store since network n₂ no longer even has network access to the system. Similarly, if partner n₄ wanted to join the system, network n₄ could be added to the system with the appropriate data stores. In either scenario, system configuration changes can be applied to the system in near real time without interrupting other operational information flows.

As noted above, to make MLSqlite multilevel, an advisory locking component can be extended to support Portable Operating System Interface for Unix (POSIX) advisory locking requests via inter-process communication (IPC). This extension is appropriate because in a multilevel environment, subjects may only obtain native advisory locks for objects existing at the same Mandatory Access Level (MAL). MLSqlite uses this IPC locking extension to interface with a secure advisory locking engine implemented as a subsystem of the trusted monitor process. The locking engine can coordinate advisory locks across multiple security levels according to the system's information flow policy. For example, network n₁ may obtain a read lock 305 for a database file d₁ that is readable only by networks n₁ and n₂, but n₁ may not obtain an exclusive lock. Similarly, network n₃ may not gain any lock on d₁ as n₃ does not have any access rights to d₁.

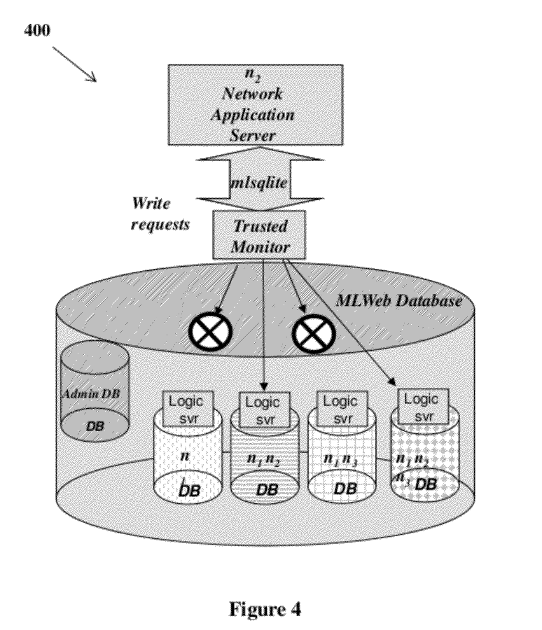

As is typically true in other database systems, applications cannot insert into views with MLSqlite. As MLSqlite is implemented in an exemplary embodiment of the invention, all insert attempts result in a runtime exception being thrown by the underlying code. The callback architecture of the system allows callbacks to be registered for runtime exceptions. Further, the system can overload the appropriate exception to take the message from the exception, package the insert request into a SQL transaction, and submit the SQL message as a database modification request to the MLWeb framework via a secure IPC mechanism. SQL messages can then be analyzed and filtered by the trusted monitor and the logic server to ensure that the SQL message does not violate the system's mandatory data transfer policies prior to final execution by the appropriate backend logic server. FIG. 4 depicts a notional information flow from an application requesting a SQL insert via MLSqlite, in accordance with an exemplary embodiment of the invention.

In prior art multilevel database systems there are many well-documented security problems that plague primary key management. However, many of these problems do not apply to MLSqlite as MLSqlite is a multilevel view of multiple single level databases in which all records have one and only one data label. Nonetheless, the primary key field can be a channel for covert information sharing, cross-domain operational interference, or transfer policy enforcement bypasses. As such, in accordance with an exemplary embodiment of the invention, three restrictions can be placed on primary keys in MLSqlite.

First, all primary keys must be typed as Globally Unique IDs (GUIDs). The use of GUIDs can ensure that primary keys are not easily predictable and that there are no primary key collisions across a multilevel MLSqlite row. For example, if data stores d₁ and d₂ both have a record in row ‘message’ with a primary key of 42, then MLSqlite would have two different records with the same primary key. Second, if MLSqlite is configured to allow primary keys to be set by the application, the schema of GUID primary keys can be validated by security filters prior to committing them to the database. Third, if MLSqlite is configured restrictively, MLSqlite-based applications may not set primary keys on records at all. Instead, applications can create records with NULL primary keys, and the backend logic servers can create the GUIDs prior to record creation. This restrictive configuration can virtually eliminate the possibility that the primary key could be used as an overt or a covert channel.

At the core of typical security information systems is some sort of information security policy. Regardless of the assurance we have that a system is properly enforcing its security policy, the level of assurance that a system is secure is necessarily bound by the assurance that the system's defined policy is secure. Similarly, the ability to determine whether a policy definition is secure is bound by the ability to map policy definitions to behaviors of the system's policy enforcement mechanisms. Therefore, in order for an MLWeb application to facilitate information sharing in the context of a dynamic coalition, the MLWeb framework must provide an assured mechanism for making policy decisions in near real time, based on a configurable system security policy.

Any policy decision component of a security system must have an assurance level that is no lower than the intended assurance level of the system itself. However, policy decision software systems are typically evaluated using a testing model exclusively. Testing is adequate for policy systems where policy definitions are relatively static; however, that can be different in the contexts where policies are changing regularly. In order to have any reasonable level of assurance in a policy system, the entire information system would have to be re-tested with the new policy. In order to avoid this expensive and laborious ‘implement-certify-deploy’ loop, in an exemplary embodiment of the system, the MLWeb system can include a policy decision system using formal software development techniques. Formal methods not only improve security and decrease system recertification costs, but also improve system reliability.

In an alternative embodiment of the invention, when a formal policy decision system is not available, the MLWeb system can include an assured, configurable policy engine that has some of the properties of the formal model. Basic properties of the MLWeb content transfer policy decision subsystem are described below.

MLWeb content transfer policies do not describe the system subjects' confidentiality, integrity, or DAC policy relationships, as these policy components are defined as part of the system's implementation of the multilevel HSA. However, these policies are content transfer policies that can describe which content types may be shared and which content types may not be shared between subjects that are collaborating via a specific resource. For example, if an MLWeb CMS site s₁ facilitates information sharing between networks n₁, n₂, and n₃, the content transfer policy for site s₁ can define which content attributes are permissible and which content types are not permissible to be shared within s₁.

In accordance with an exemplary embodiment of the invention sample information flow policy for a sample site can include CONSTRAINTS, DEFINITIONS, AND RULES. For example:

Constraints
a. Network n₁ NEVER allows power point files
b. Network n₂ NEVER allows png files

### DEFINITIONS

1. ‘Image’ objects are one of: {‘jpeg’, ‘gif’, ‘png’, ‘bmp’}

2. ‘MS Office’ objects are one of: {‘power point’, ‘word’, ‘excel’}

3. All objects with ‘hidden content’ OR ‘macros’ are ‘dirty’

4. An object containing ‘text-background color matches’ or ‘text out of viewing bounds’ has ‘hidden content’

Rules

1. All objects that are NOT ‘dirty’ AND are of type ‘MS Office’ are permitted

2. ‘ZIP’ files are prohibited

3. Any ‘image’ is permitted

In this example, some attributes of the policy language are demonstrated. First, the constraints section demonstrates that each network has an opportunity to express environmental restrictions. That is, regardless of the policy, enclave constraints can be used to ensure that coalition partners may further restrict information flows according to their domain's security policy. Rules 1, 2, and 3 demonstrate that some objects attributes can be permitted while others can be prohibited, thus demonstrating that the policy language supports both permissions and prohibitions. Definitions 1, 2, and 3 together demonstrate that the policy also supports rules that use terms defined elsewhere in the policy, thus the language allows term definition chaining in addition to reasoning about literals. Rule 1 demonstrates that limited negation is allowed in rule antecedents.

With a policy example disclosed above, determining what the policy means (i.e., policy interpretation) is the next step. First, the policy is non-ordered, so this policy can have precisely the same meaning if the statements were re-ordered; however, statements groupings are necessary, as valid definitions are not valid rules, and rules are not valid constraints, etc. In the policy example, since ZIP objects are prohibited and image objects are permitted, a file transfer request for a zipped image object could result in a contradiction, and thus the policy engine would return a result of CONTRADICTION. Policy constraints can be interpreted as pre-processor directives at initialization time. As such, this policy would not initialize at boot time, as it states that all ‘MS office’ objects are permitted while network n₁ states that it never allows ‘power point’ object transfers. If a system implementation were to try to initialize with this policy, the system would raise a warning at initialization stating that the policy is invalid because ‘power point’ objects are both permitted and denied. If a policy query were submitted for an object of type ‘tiff’, the policy would yield an UNGOVERNED response, as the policy has no knowledge of ‘tiff’ objects. If a query were submitted for an object whose only attributes were ‘jpeg’ and ‘excel’, the query would yield ‘PERMIT’, as ‘jpeg’ objects are permitted by virtue of rule 3 and definition 1, while ‘excel’ objects are permitted by virtue of rule 1 and definition 2. Note that if a query were submitted for an object with ‘excel’, ‘jpeg’, and ‘tiff’ attributes were submitted, the policy would yield UNGOVERNED, as the ‘tiff’ attribute is not governed anywhere in the policy, so the query cannot be fully resolved.

Content transfer policy enforcement can be executed in three phases: analysis, decision, and execution. This section describes the decision portion of the process, and other sections herein have described the multilevel HSA scheme for transfer policy enforcement. A typical question regarding enforcement is the degree of assurance that the facts presented in this section represent the facts about the data object in question. For example, what is the assurance that an object that is asserted to contain ‘excel’ and ‘jpeg’ does not also contain ‘zip’ objects, or that the ‘jpeg’ object is actually a well-formed jpeg, and not a mobile code object? While the policy engine component reasons about security policies, the facts regarding a given policy query should be and can be provided by an external process. Recursive, comprehensive content analysis is executed in the content checking subsystem, which is another high integrity, decision support component of the MLWeb system.

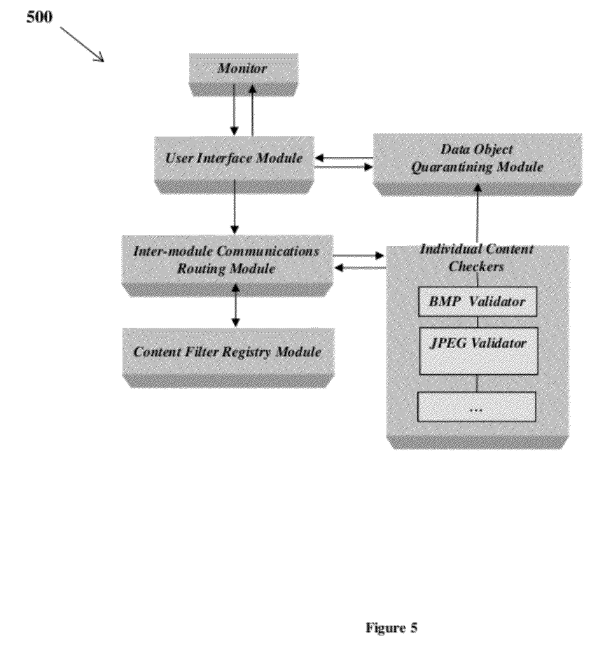

FIG. 5 is a flow chart of the content checker system, in accordance with an exemplary embodiment of the invention. While the content checking subsystem of the MLWeb framework is an implemented control, the actual content validating modules can be per-implementation, integrated inherited controls. This arrangement allows for the certification of the MLWeb framework baseline, but the tailoring of the system for each environment. It is noteworthy that the content checking framework can be tailored not only according to the content type support requirements of the implementation environment, but also according to different content checking technology preferences of the implementation environment. For example, one accreditor may prefer product ‘X’ for image validation, while another accreditor may prefer product ‘Y’.

Managing the accreditation of dynamic policies can be a difficult task. For example, if an organization wants to change its accredited policy, it typically must obtain an accreditation of the new policy, which can be a grueling process. In order to address this problem, the policy system of an exemplary embodiment of the invention includes a notion of ‘policy compliance.’ It can enable a system where an accreditor can approve a baseline policy, and organizations may change policies so long as their policies ‘comply’ with the baseline accredited policy. The definition of policy compliance in this context can be:

Implemented policy p₁ complies with accredited policy P₁ if and only if:

a. Nothing prohibited by P₁ is permitted by p₁

b. Nothing explicitly prohibited by p₁ is permitted by P₁

Therefore, an organization can tailor their policy to be more restrictive than the accredited baseline policy, so long as they are not restricting an information flow that the accredited policy states must be allowed. While this definition of compliance can be quite restrictive, it does provide a minimal framework for policy ‘tweaking’ with only minimal work associated with policy re-accreditation.

Presently, one of the most popular applications of web technology is the Content Management System (CMS). CMS applications can allow non-developers to manage a web site. The MLWeb CMS disclosed herein is an application that can provide basic content management services across multiples security enclaves. Specifically, there are multiple functional capabilities of this system. For example, the application can support multiple sites, wherein each site can have different DAC policies and label accreditation ranges. Furthermore, in the MLWeb system's administrative database all subjects must be properly registered; however, the application does not require that users authenticate to it directly. Instead, the application can subscribe to authentication services via a predefined source. Another feature of the MLWeb CMS is that the application can allow authorized users to create, edit, and/or delete rich text, labeled messages on a per-site basis. Finally, the application can enable authorized users to post unlabeled files to a site so long as they associate the file with a permitted security label.

The MLWeb system can host an administrative web application (called a User Management System (UMS)) for managing the discretionary access control policies for system objects. Since all system resource objects (e.g., sites, user clearances, ACLs, etc.) are managed through an out-of-band administrative network that connects to the UMS server, the CMS can have a MAC-enforced, read-only relationship with the administrative database. Since the schema for this database is tied to the MLWeb system, all administrative data objects must be bound to CMS objects at runtime. Intermediate classes can be implemented that extend the CMS administrative objects. These classes can virtualize object attributes, which come from the administrative database.

For example, if the CMS has a site object ‘s’ of class CMSSite, ‘s’ can be bound at runtime to an object a which can contain the security relevant properties of that site, such as the sites ACL. Therefore, while class CMSSite does not have an ‘ad’ attribute, an invocation of the method ‘ad’ on object ‘s’ could yield the sites ACL according to the state of ‘a.’ This loose coupling of the administrative database to the application database can enable the MLWeb CMS to enforce the system's DAC policy using a MAC-protected, high integrity data source. Since this arrangement can present the administrative attributes as part of the CMS, web application developers would not need access to the administrative database or its schema; therefore, the application can be implemented with all administrative attributes native to CMSSite. This arrangement not only can increase system assurance and facilitate more flexible software, but it can enable software development teams to make use of non-security experts to implement substantial portions of the CMS.

In order to move content between security enclaves, the system must ensure that all content complies with a strictly defined, accredited content transfer policy. Therefore, many of the details regarding schema definition must be carefully considered at design time. Each data field must be constrained to particular content subsets, which can be properly validated prior to committing to the database. Similarly, if a content type is not properly restricted, security testers could find a way to exploit the vulnerability, violate the content transfer policy, and thus potentially prevent the system from achieving a satisfactory system certification level.

File posting support is typically difficult to implement in traditional CMS systems, and can be even more difficult to implement in the multilevel CMS application disclosed herein. Specifically, at least three substantial challenges can be present when implementing File posting support within the MLWeb system.

The first challenge deals with file system MAC integration. Unlike simple content messages, which can be packaged into IPC objects, file posting support is integrally tied to the file system. Secure file systems (e.g., the FFS file system used by the STOP OS) implement the monotonic non-decreasing rule with respect to file system object MAC labels. The monotonic non-decreasing rule cannot be violated by any system subject, even if that subject is a privileged process such as the trusted monitor. Implementing a file analysis transfer system that can support secure file processing and analysis, yet never violate the monotonic non-decreasing rule can be challenging.

Secondly, the challenge of metadata security. When posted to the system, files are typically posted with specific file names and paths. Ensuring that the fully qualified file name itself meets the systems content transfer policy means that the file name had to be stored in the database and analyzed as normal content. Furthermore, the MLWeb secure IPC mechanism does not allow for free-form strings, so fully qualified file paths can be normalized according to a pre-defined algorithm so that the file path can be represented in a form other than a 4096 byte free string (i.e., the normal type of a file path).

Finally, asynchronous status notification is a challenge when implementing File posting support within the MLWeb system. Files posted to the system can be recursively analyzed to ensure that they comply with the system's file transfer policy. This process can take anywhere from several seconds to several minutes, depending on the complexity of the file and the system's resource utilization level. As such, users typically cannot wait for a file to complete the posting process before ‘moving on’. Therefore, a mechanism can be implemented where the CMS can allow the user's session to continue operating during the file analysis process, yet inform the user of the status of the file posting request when analysis is finally completed.

A shortcoming of the prior art implementation of the HSA was that all data sanitization was only executed in the untrusted application space. With the introduction of the logic server components in the MLWeb system in accordance with an exemplary embodiment of the invention, data sanitization and validation can be re-executed on the back end. This arrangement can not only improve system assurance, but it can allow the certification boundary for content transfer policy enforcement to be reduced to exclude the CMS application. While the CMS application is aware of the context of data fields and can thus validate particular attributes, the logic server must execute the content validation process on a raw SQL string. The following is a notional view of a web application's data validation process.

msg = svr.read_from_client =>
[title = <script>alert</script>; body = “owned”, ...]
msg.title => “<script>alert</script>”
MsgValidator.validate_title_of(msg) => false

Therefore, the logic server must validate that the title is appropriate via analysis on a raw SQL query string. The following is a notional view of how the logic server could validate a string prior to committing that string to the database.

```
msg = svr.read_from_monitor =>
  “BEGIN TRANSACTION;
    Insert into messages (title, body) values (“<script>alert</script”,
    “owned”);
  COMMIT;”
parsed_msg = Parser.parse(msg) //must implement a parser for
SQL strings!
MsgValidator.validate(:title => msg_ary[:title], :body =>
msg_ary[:body]) => false
```

In order to implement this sort of raw SQL string validation the implementation of a parser that could process a limited subset of the SQL language is required. Not only must the SQL message contents comply with the content transfer policy, but the SQL message sent to the logic server must comply with a pre-defined subset of the SQL language. Therefore, not only can the content of the SQL message be validated prior to processing, but the means by which the contents are processed (i.e., the SQL query's keywords, structure, etc.) can be validated as well.

The widespread growth in web applications has lead to an explosion in the number of passwords that people must maintain. Furthermore, many applications have implemented their own “stovepipe” authentication mechanisms, which are often insecure implementations. As single sign-on technologies have advanced in the past decade, an increasing number of enterprise systems have deployed enterprise authentication systems, or even integrated one of the competing internet-based authentication systems, such as OpenID. In order to enable the MLWeb CMS to integrate with different enterprise authentication services, the system can use a RESTFul authentication scheme that can be tied to an external authentication service. While there are several competing Authentication standards, the MLWeb CMS was coded against the Central Authentication Server (CAS) open interface. This implementation can allow for easy integration into an existing authentication system, yet provided the flexibility to migrate to other systems that implement CAS interfaces, as appropriate.

To demonstrate the concept, the CAS server used for MLWeb may support the standard username/password implementation of CAS, or it can require that users be authenticated using the Arcot WebFort server. While WebFort is a proprietary strong authentication system, the CMS development team was able to implement a CAS front end for WebFort using WebFort's web services API. However, if a user of the MLWeb system wanted to use their own authentication system (e.g., ActiveDirectory, SecureID, etc.), a CAS adapter for that system could be implemented if necessary and integrated into the CMS with relative ease.

In a preferred embodiment of the CMS implementation, DAC enforcement could be completely modularized into a DAC engine that all applications built on the MLWeb framework could simply invoke when making access control decisions. To this end, UMS-aware middleware, described herein, can easily be integrated into the applications data modelling classes and application controllers. However, the system still lacks a general purpose authorization engine that can make DAC enforcement access control decisions. To overcome this issue, any application built on the MLWeb framework with a requirement to support per-site ACLs can do the following steps. First, the application can integrate the administrative database with their application resource classes (e.g., either using the classes provided with the MLWeb CMS or using some other mechanism). Secondly, the application can integrate an authentication plug-in (e.g., using the CAS plug-in from the CMS or through some other mechanism). Finally, the application can implement business logic in the business logic and controller classes that uses the above two mechanisms as the source for access control decisions

Finally, most applications have extensive log and/or audit mechanisms that system administrators use for a wide range of purposes. Tailoring the system's log and audit mechanisms to interoperate with the MLWeb frameworks logging and auditing subsystem can utilize a log adapter that can differentiate between “line noise” log messages that should not be processed by the MLWeb framework, and log and audit messages that should be processed by the MLWeb framework.

In summary, and accordance with an exemplary embodiment, the MLWeb system has many advantages over prior art solutions. For example, MLWeb can have a plug-in architecture for scanning and sanitizing files being posted to MLWeb. The system's content checking framework can allow the implementor to ‘mix and match’ different content scanning, extraction, and sanitization tools. For example, one MLWeb implementation can use vendor A's application for imagery scanning, vendor B's application for Microsoft Office sanitization, and an open source application for extracting objects from a Zip file. Similarly, another MLWeb implementation could use a completely different configuration.

Another advantage is the multi-tiered database security in MLWeb. MLWeb filters data fields being posted via multiple separate processes that use different libraries and parsers to ensure that the system's data store is protected from various attacks such as cross-site scripting and SQL injection. Because security analysis can be performed when the data is first consumed by the server process, again before it is routed by the security framework, and finally before it is committed to the database by the business logic process, the likelihood that a malicious data string could exploit a vulnerability is greatly mitigated. Not only can each process perform security analysis separately, but also they can all use different libraries and string parsers to minimize the risk that a single vulnerability and/or design flaw could lead to an overall system compromise.

The hybrid security architecture of the MLWeb system is also an advantage. MLWeb does not rely on a high assurance guard to ensure data being replicated between servers on different networks cannot cause an inter-network security exploit to occur. Rather, MLWeb can use a security architecture that is innately aware of the different networks it is connected to, and is able to enforce the networks' security policies natively. As such, users in each network can continue to use commercial off the shelf (COTS) client systems to communicate with users on other networks, yet they can realize the assurance that would require either additional, special-purpose clients to secure data to go through a guard, or a special trusted access solution for all users. Furthermore, since MLWeb was designed to support multiple networks and multiple data policies, the number of servers must scale according to throughput and storage requirements, rather than scaling according to the number of networks, as is typically the case with prior art trusted transfer solutions.

A final advantage of MLWeb, though others are disclosed herein, is integrated trusted labeling. Typically, database systems that support trusted labels maintain their own trusted label scheme. As such, when the database is integrated with another trusted system (e.g., a trusted operating system), additional security code must be developed to ensure that the database's trusted labels are tied to the trusted labels of all other systems in a manner that does not diminish the overall system's security posture. However, because MLWeb's database scheme inherits its trust from the operating system, there is no need to map system security policies to the database's security policy using trusted middleware. The result of this approach is increased system assurance with less developmental and testing overhead.

The invention can be used with computer hardware and software that performs the methods and processing functions described above. As will be appreciated by one of skill in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The invention can comprise a computer program that embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement an exemplary embodiment based on the flow charts and associated description in the application text. Therefore, disclosure of a particular set of program code instructions is not considered necessary for an adequate understanding of how to make and use the invention. The inventive functionality of the claimed computer program is described in more detail herein in conjunction with the figures illustrating the program flow.

It should be understood that the foregoing relates only to illustrative embodiments of the present invention, and that numerous changes may be made therein without departing from the scope and spirit of the invention as defined by the following claims.

1. A method of transferring data from a server via a web application, comprising the steps of:
receiving a request from a user operating on a network in a disparate security domain for data on a multilevel data store;
generating a labeled view of the data requested from the multilevel data store, wherein the label-data relationship can be trusted at a level commensurate to the trust level of the OS;
determining if the data is authorized by a security policy with a policy design engine; and
transmitting the data to the user if the data is authorized.

2. The method of claim 1, further comprising the steps of:
receiving a data flow from the user operating on the network in the disparate security domain for writing to the multilevel data store;
inspecting the data flow for disallowed and mislabeled content;
determining if the data flow is authorized by the security policy; and
if the data flow is authorized, authorizing the data flow and mediating the data flow between the user and the multilevel data store with a trusted monitor component.

3. A cross domain system, comprising:
a plurality of connections to users on networks in disparate security domains;
a content server configured to extend multilevel web services to the users;
a trusted monitor component configured to mediate all information flows that occur between the users and the cross domain solutions;
a multilevel data store configured to read and write data from the users depending on a determination by a policy decision engine on whether the given data is authorized by a security policy.
